(19) United States
(12) Patent Application Publication
(10) Pub. No.: US 2026/0071459 A1
(43) Pub. Date: Mar. 12, 2026

(54) Inflatable LED Glow Tent

(71) Applicant: Reginald L. Selden, JR., Franklinville, NJ (US)

(72) Inventor: Reginald L. Selden, JR., Franklinville, NJ (US)

(21) Appl. No.: 19/320,285

(22) Filed: Sep. 5, 2025

Related U.S. Application Data
(60) Provisional application No. 63/691,636, filed on Sep. 6, 2024.

(51) Int. Cl. E04H 15/10; E04H 15/20; E04H 15/58; F21V 3/02; F21Y 113/10; F21Y 115/10; G09F 7/18

(52) U.S. Cl. CPC E04H 15/10; E04H 15/20; E04H 15/58; F21V 3/026; G09F 7/18; E04H 2015/201; E04H 2015/206; E04H 2015/209; F21Y 2113/10; F21Y 2115/10; G09F 2007/1856

(57) ABSTRACT

An inflatable LED glow tent that also provides lighting with multiple colors and effects. The inflatable LED glow tent is a spider tent with a black outer shell and a white inner shell having a plurality of inflatable legs. The inflatable LED glow tent is blown-up by an inflation source to expand into an inflated LED glow tent and includes multiple color lighting and provides a luxury feel to its users. An additional embodiment of the inflatable LED glow tent also includes a false front.

### CROSS-REFERENCE TO RELATED APPLICATIONS

This Non-Provisional Patent Application claims the benefit of U.S. Provisional Ser. No. 63/691,636 filed on Sep. 6, 2024. The above identified patent application is herein incorporated by reference in its entirety to provide continuity of disclosure.

### BACKGROUND OF THE INVENTION

The present invention relates to a tent. More specifically, the present invention relates to an inflatable LED glow tent.

Tents are wonderful for outdoor venues such as tailgating, state fairs, and even outdoor weddings and parties. These tents are often cumbersome to set-up and require separate lighting as part of an event.

What is needed is an inflatable LED glow tent that also provides lighting with multiple colors and effects.

### SUMMARY OF THE INVENTION

In view of the foregoing disadvantages inherent in the known types of inflatable LED glow tents now present in the prior art, the present invention provides an inflatable LED glow tent wherein the same may be utilized for providing convenience for a user when utilizing an inflatable LED glow tent.

The present system is an inflatable LED glow tent that comprises a plurality of lights emitting a plurality of light colors, a plurality of inflatable legs inflated and expanded by an inflation source, an inner shell including the inflatable legs, and an outer shell disposed over the inner shell, and wherein the outer shell is configured to extend over the inflatable legs to a ground surface.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an inflatable LED glow tent.

FIG. 2 shows a front perspective view of an inflatable LED glow tent.

FIG. 3 shows a front perspective view of an inflatable LED glow tent.

FIG. 4 shows a bottom perspective view of an inflatable LED glow tent.

FIG. 5 shows a side perspective view of an inflatable LED glow tent.

FIG. 6 shows a top view, a perspective view, a front view, and a side view of an inflatable LED glow tent.

FIG. 7 shows a front view of an inflatable LED glow tent with a false front.

FIG. 8 shows a front view of an inflatable LED glow tent with a false front and a plurality of screening.

FIG. 9 shows an environmental perspective view of an inflatable LED glow tent with a false front.

### DETAILED DESCRIPTION OF THE INVENTION

Reference is made herein to the attached drawings. Like reference numerals are used throughout the drawings to depict like or similar elements of the inflatable LED glow tent. The figures are intended for representative purposes only and should not be considered to be limiting in any respect.

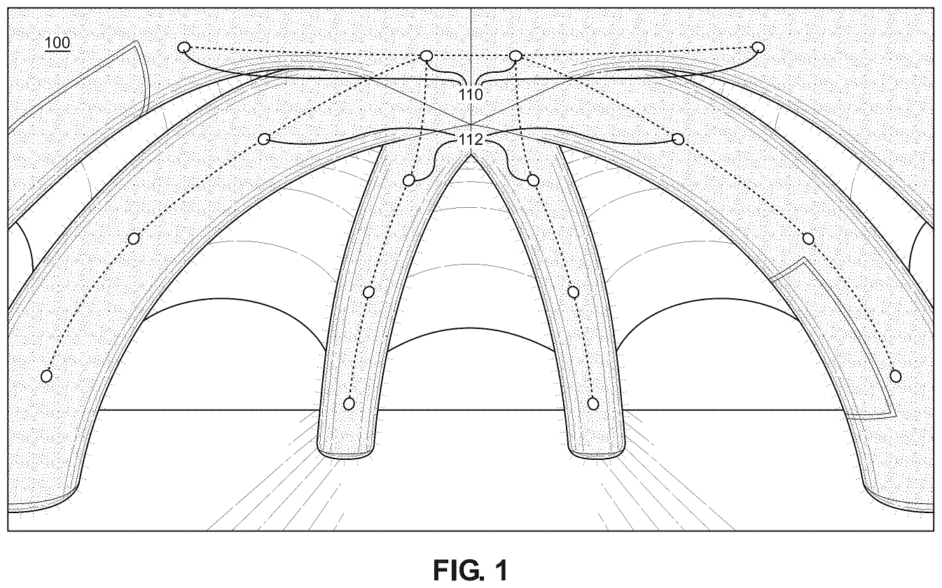

Referring now to FIG. 1, there is shown a front perspective view of an inflatable LED glow tent 100.

The inflatable LED glow tent 100 shows a colored light being emitted by a plurality of lights 110.

The plurality of lights 110 may be a plurality of light-emitting diodes or LEDs 112 that emit the colored light.

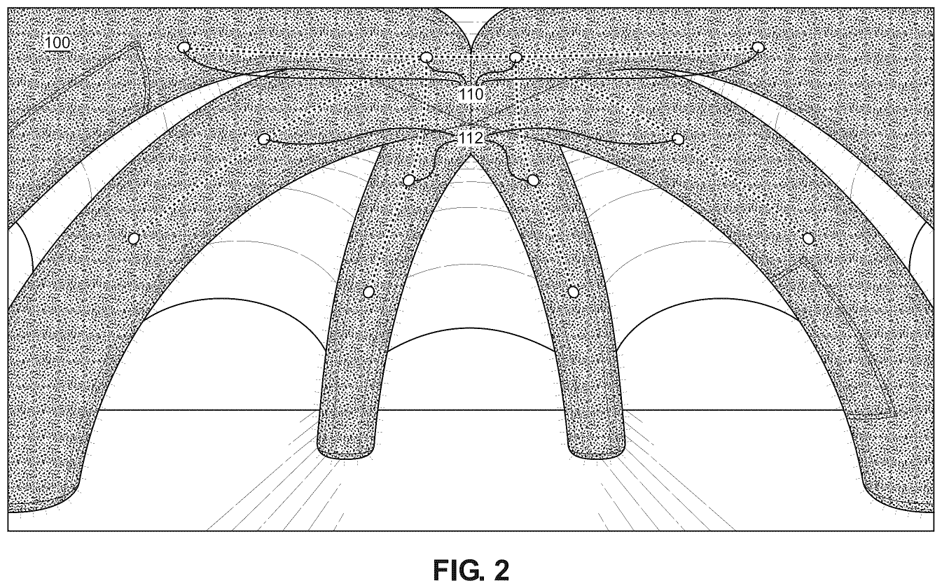

Referring now to FIG. 2, there is shown a front perspective view of an inflatable LED glow tent 100.

The LEDs 112 may emit a plurality of colored light.

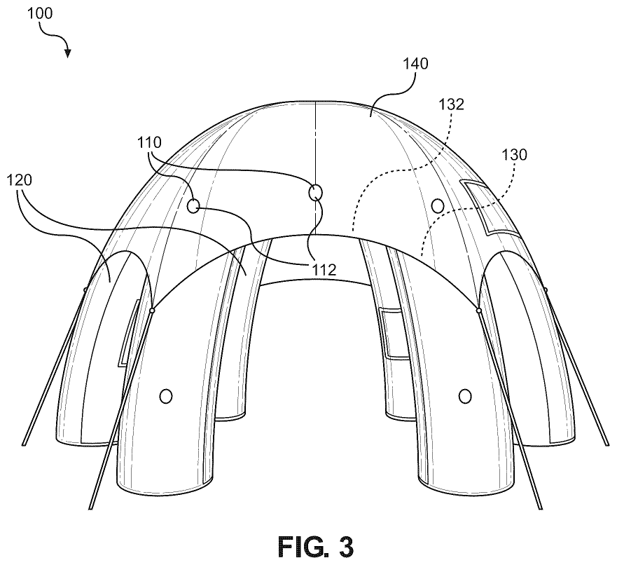

Referring now to FIG. 3, there is shown a front perspective view of an inflatable LED glow tent 100.

The inflatable LED glow tent 100 may include a plurality of legs 120, an inner shell 130, and an outer shell 140.

The legs 120 may be inflatable and are expanded by an inflation source 122 such as a pump (not shown) or the like. The inflation source 122 and the lights 110, which may be the LED lights 112, may both be powered by an electrical plug 114. The legs 120 may have a white color or the like. The inner shell 130 may include an outer surface 132 and 6 of the legs 120. The outer shell 140 may also have a black color. The outer surface 132 of the inner shell 130 may be positioned underneath the outer shell 140 and the lights 110 may be disposed on the outer surface 132 of the inner shell 130 to allow the inner shell 130 to glow without seeing the lights 110. The outer shell 140 may be detachable to facilitate changing the lights 110 to change color and glow produced from the lights 110.

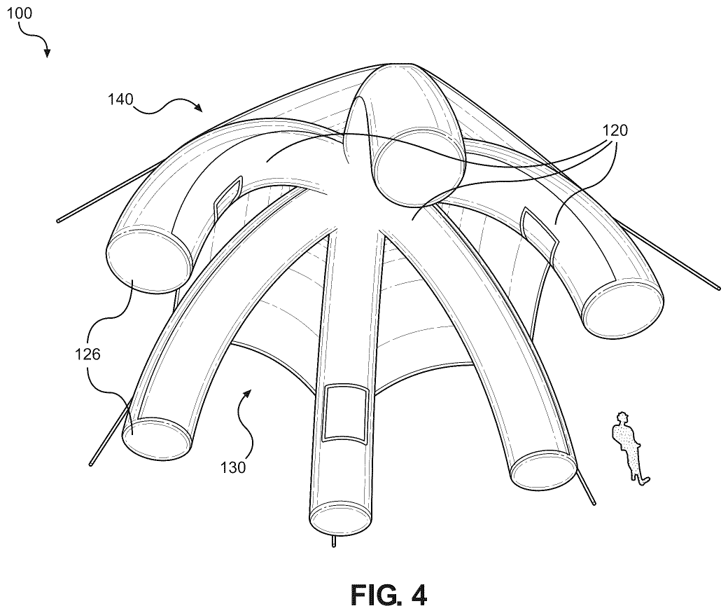

Referring now to FIG. 4, there is shown a bottom perspective view of an inflatable LED glow tent 100.

The inflatable LED glow tent 100 may show a bottom 126 of each of the 6 legs 120 and an inner surface of the outer shell 140.

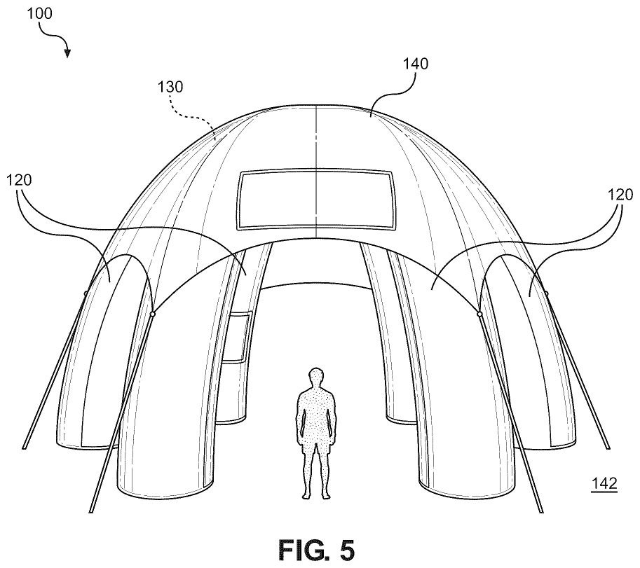

Referring now to FIG. 5, there is shown a side perspective view of an inflatable LED glow tent 100.

The inflatable LED glow tent 100 may include the outer shell 140 that may be disposed over the inner shell 130 and extend over the 6 legs 120 to a ground surface 142.

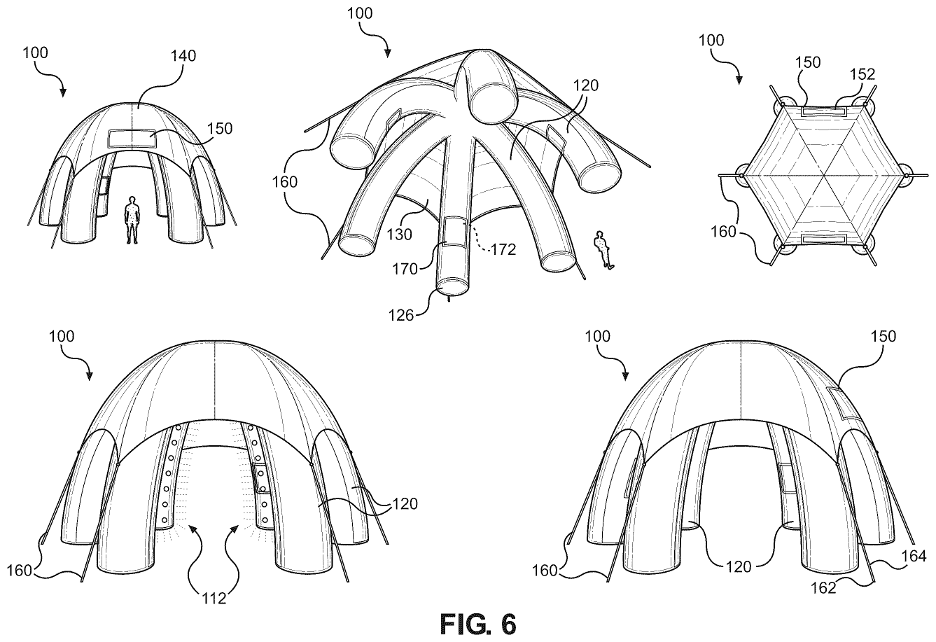

Referring now to FIG. 6, there is shown a top view, a perspective view, a front view, and a side view of an inflatable LED glow tent 100.

The inflatable LED glow tent 100 may include a plurality of banners 150 and a plurality of tie-down lines 160.

The banners 150 may be disposed conspicuously on the legs 120, the inner shell 130, or the outer shell 140 and may include any suitable indicia or advertising. More specifically, the banners 150 may be fastened conspicuously on the legs 120, the inner shell 130, or the outer shell 140 with one or more hook and loop or VELCRO® fasteners 152 or the like.

Each of the tie-down lines 160 may be attached to the outer shell 140 at a first end and be secured into the ground surface 142 at a second end with a ground stake 162 driven into the ground surface 142 and an eyebolt 164 to receive and couple each of the tie-down lines 160 and to prevent the inflatable LED glow tent 100 from moving and being taken away by wind and the like.

The light-emitting diodes or LEDs 112 may be strapped on the back of the inner shell 130 in between the inner shell 130 and the outer shell 140 to make the inflatable LED glow tent 100 glow without seeing the LED lights 112. The outer shell 140 may also be transparent or opaque or the like and be inflatable.

The inflatable LED glow tent 100 may include the inner surface of the outer shell 140 being attached to the bottom 126 of each of the 6 legs 120. There may be a pocket 170 disposed between the bottom 126 of each of the 6 legs 120 and the inner shell 130 to contain a weight source 172, such as sand or the like, or one or more sand bags, to hold down the inflatable LED glow tent 100 when the tie-down lines 160 are not used.

The LED lights 112 may emit a plurality of red light, a plurality of blue light, a plurality of green light, a plurality of purple light, a plurality of pink light, a plurality of yellow light, or the like. The LED lights 112 may change its emitted light from a plurality of red light, a plurality of blue light, a plurality of green light, a plurality of purple light, a plurality of pink light, or a plurality of yellow light, in any sequence or pattern.

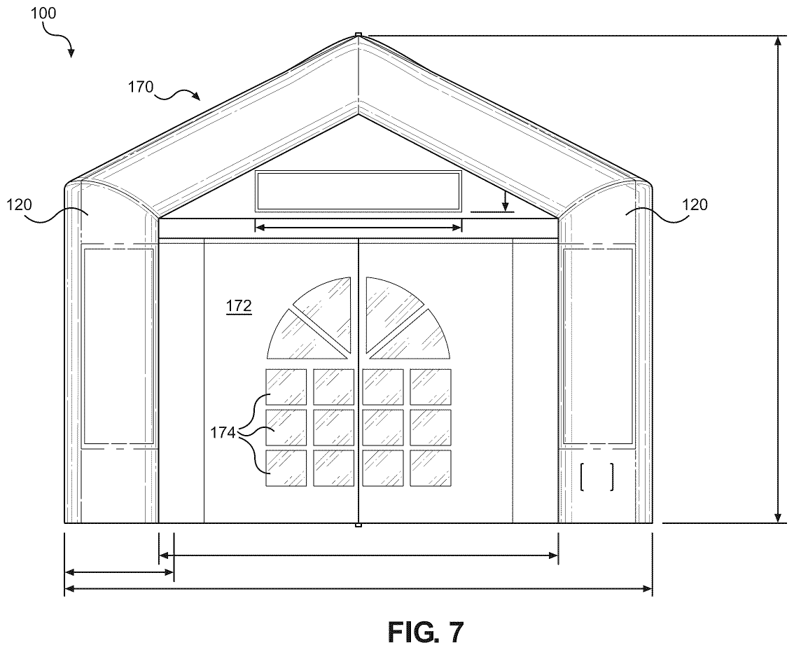

Referring now to FIG. 7, there is shown a front view of an inflatable LED glow tent 100 with a false front 170.

The false front 170 may be disposed between 2 of the 6 legs 120 and includes a pair of doors 174 and a plurality of windows 176 disposed on the pair of doors 174.

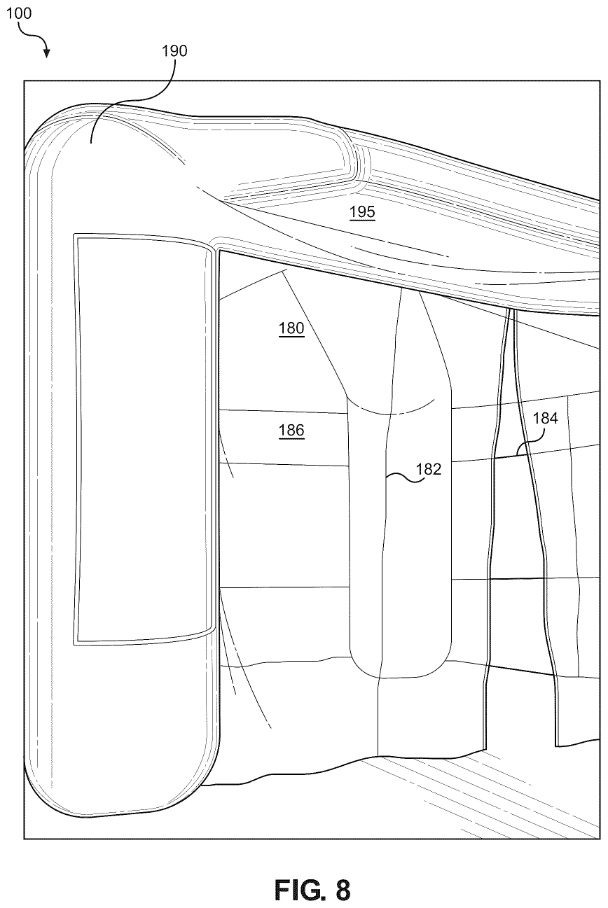

Referring now to FIG. 8, there is shown a front view of an inflatable LED glow tent 100 with a plurality of screening 180.

The screening 180 may include a zipper 182 or a piece of reusable tape 184 to fasten the screening 180 that is open and that is disposed between the 6 legs 120 to enclose the inflatable LED glow tent 100. The screening 180 may be a plurality of mesh material 186 or the like.

The inflatable LED glow tent 100 may include an inlet 190 that may receive inflatable air from the inflation source (FIGS. 3, 122) to inflate the inflatable LED glow tent 100. The inflation source 122 and the lights 110, which may be LED lights 112, may be powered by an electrical plug 114. The inflatable LED glow tent 100 may include an top overhang 195 protruding from the top of the inflatable LED glow tent 100 to provide additional shelter immediately outside of the inflatable LED glow tent 100.

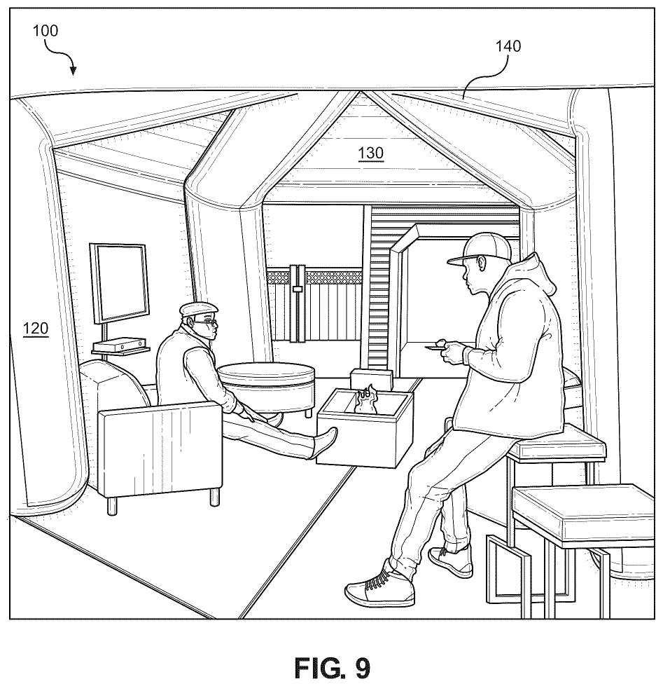

Referring now to FIG. 9, there is shown an environmental perspective view of an inflatable LED glow tent 100.

The legs 120, an inner shell 130, and an outer shell 140 may be made of Oxford cloth material that is relatively cleaner and relatively more stylish than other traditional materials such as canvas, vinyl, Nylon or the like.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An inflatable glow tent, comprising:
a plurality of lights emitting a plurality of light colors;
a plurality of inflatable legs inflated and expanded by an inflation source;
an inner shell including the inflatable legs; and
an outer shell disposed over the inner shell;
wherein the outer shell is adapted to extend over the inflatable legs to a ground surface.

2. The inflatable glow tent, according to claim 1, further comprising a plurality of banners coupled conspicuously on the inflatable legs, the inner shell, or the outer shell with one or more hook and loop fasteners.

3. The inflatable glow tent, according to claim 2, wherein the banners include a plurality of indicia.

4. The inflatable glow tent, according to claim 3, wherein the indicia include a plurality of advertising.

5. The inflatable glow tent, according to claim 1, wherein an outer surface of the inner shell is positioned underneath the outer shell and the lights are disposed on the outer surface of the inner shell to allow the inner shell to glow without seeing the lights.

6. The inflatable glow tent, according to claim 5, wherein the outer shell is detachable to facilitate changing the lights to change color and glow produced from the lights.

7. The inflatable glow tent, according to claim 1, further comprising a plurality of tie-down lines.

8. The inflatable glow tent, according to claim 7, wherein the tie-down lines are attached to the outer shell at a first end and secured into the ground surface at a second end.

9. The inflatable glow tent, according to claim 8, wherein the tie-down lines are secured into the ground surface at the second end with a ground stake driven into the ground surface and an eyebolt to receive and couple each of the tie-down lines.

10. The inflatable glow tent, according to claim 1, wherein the light colors are selected from the group consisting of a plurality of red light, a plurality of blue light, a plurality of green light, a plurality of purple light, a plurality of pink light, and a plurality of yellow light.

11. The inflatable glow tent, according to claim 1, further comprising an inlet that receives inflatable air from the inflation source to inflate the inflatable LED glow tent.

12. The inflatable glow tent, according to claim 11, wherein the inflation source and the lights are powered by an electrical plug.

13. The inflatable glow tent, according to claim 1, further comprising a pocket disposed between the bottom of each of the legs and the inner shell to contain a weight source to hold down the inflatable glow tent when the tie-down lines are not used.

14. The inflatable glow tent, according to claim 1, wherein the inflatable legs, the inner shell, and the outer shell are made of Oxford cloth material.

15. The inflatable glow tent, according to claim 1, further comprising a false front disposed between 2 of the inflatable legs.

16. The inflatable glow tent, according to claim 15, wherein the false front includes a pair of doors and a plurality of windows disposed on the pair of doors.

17. The inflatable glow tent, according to claim 16, further comprising a plurality of screening that includes a zipper to fasten the screening that is open and that is disposed between the inflatable legs to enclose the inflatable LED glow tent.

18. The inflatable glow tent, according to claim 17, wherein the screening includes a piece of reusable tape to fasten the screening that is open and that is disposed between the inflatable legs to enclose the inflatable LED glow tent.

19. The inflatable glow tent, according to claim 18, wherein the screening is a plurality of mesh material.

20. The inflatable glow tent, according to claim 15, further comprising a top overhang protruding from the top of the inflatable LED glow tent to provide additional shelter immediately outside of the inflatable LED glow tent.
